(19) United States
(12) Patent Application Publication
(10) Pub. No.: US 2009/0136035 A1
(43) Pub. Date: May 28, 2009

(54) Public key infrastructure-based bluetooth smart-key system and operating method thereof

(75) Inventor: Saeng-Hee Lee, Suwon-si (KR)

Correspondence Address: DOCKET CLERK, P.O. DRAWER 800889, DALLAS, TX, 75380, US

(73) Assignee: SAMSUNG ELECTRONICS Co., LTD., Suwon-si (KR)

(21) Appl. No.: 12/286,609

(22) Filed: Oct. 1, 2008

(30) Foreign Application Priority Data
Nov. 27, 2007 (KR) 2007-0121344

(51) Int. Cl. H04K 1/00

(52) U.S. Cl. 380/270

(57) ABSTRACT

A public key infrastructure (PKI)-based Bluetooth smart-key system and operating method thereof. The system includes a locking device and a mobile communication terminal. The locking device enables Bluetooth communication and enables PKI-based data transmission. The mobile communication terminal embedded with a Bluetooth module performs a remote unlocking or keyless entry function through Bluetooth communication with the locking device.

### CROSS-REFERENCE TO RELATED APPLICATION(S) AND CLAIM OF PRIORITY

This application claims the benefit under 35 U.S.C. §119 from an application entitled “PUBLIC KEY INFRASTRUCTURE-BASED BLUETOOTH SMART-KEY SYSTEM AND OPERATING METHOD THEREOF” filed on Nov. 27, 2007 and assigned Serial No. 2007-0121344, the entire contents of which are hereby incorporated herein by reference.

### TECHNICAL FIELD OF THE INVENTION

The present invention relates to a technology for automatically performing an unlocking or keyless entry operation without a separate physical unlocking tool (e.g., a key) by wirelessly transmitting a control signal to a locking device using a mobile communication terminal and, more particularly, to a smart key system for controlling a variety of kinds of locking device operations using a mobile communication terminal that enables Bluetooth communication, and an operating method thereof.

### BACKGROUND OF THE INVENTION

In recent years, a remote control system or a smart key system is being used for the remote wireless control of a range of devices including opening/closing of a door or a locking device of a vehicle, on/off switching of an electric light, or operating home appliances, etc. In general, such a remote control system or smart key system transmits control signals to control targets in a remote place through a remote controller, etc. using an Infrared Data Association (IrDA) method, thereby controlling operations of the control targets.

IrDA is a particular form of wireless communication for performing data transmission between equipments without a cable using infrared rays according to its name. IrDA is basically a local area communication technology operating only within a distance of 1 meter (m). Because of its directional feature enabling transmission/reception of data only in a specific direction, IrDA communication is established just as long as the IrDA ports are facing each other as a remote controller is directed toward a television set (TV) in a sensor-to-sensor fashion. Thus, IrDA is currently applied/used in various devices as well as remote control smart-key systems because of its convenience. For reference, IrDA standards are Serial InfraRed (SIR) and Fast InfraRed (FIR). The SIR is a version 1.0 standard having the maximum operation speed of 115.2 Kbps. The FIR is a version 1.1 standard having the maximum operation speed of 4 to 16 Mbps.

However, IrDA used for smart key systems has a drawback in that IrDA cannot be used to establish communication between devices that differ in manufacturer, signal transmission method, and so forth, due to the aforementioned directional feature (i.e., a point-to-point communication for connection between equipments), and its control signal generally exists only for one device. Also, IrDA has a drawback in terms of cost and safekeeping resulting from the plurality of remote control devices that a user has to separately maintain to control respective control target devices (e.g., a door and a car door) because an IrDA transmission/reception device for controlling a door opening/closing device is not compatible with a different IrDA opening/closing device for opening/closing a car door. In order to overcome the aforementioned drawbacks, a Bluetooth smart key system is currently under active development. Bluetooth communication is described below.

Like IrDA, Bluetooth is a local area wireless communication technology, and can operate at an Industrial Scientific and Medical (ISM) frequency band of 2.4 GHz, which does not requiring a license any where in the world and transmits voice and data at a maximum rate of 1 Mbps in a radius of 10 m. Also, Bluetooth can maintain uniform transmission performance even under a heavily noisy wireless environment through a frequency hopping scheme in which 79 channels of a 1 MHz bandwidth are set at a 2.4 GHz frequency band and a transmission channel is changed at a high speed.

Unlike IrDA, Bluetooth has a feature of point-to-multipoint (1:N) communication in which several devices are connected with each other using a non-directional radio frequency having no directional limit. So, as long as a Bluetooth chipset relatively cheap and smaller in size than a thumbnail is installed in a device, wireless communication can be performed. Therefore, several devices having Bluetooth modules can be variously configured.

Regarding a general Bluetooth operating method, a central control unit searches and selects a peripheral Bluetooth device and, in cases where authentication is needed, pairs and allows two Bluetooth devices to communicate with each other, so wireless communication is initiated. If an initial setup of a Bluetooth module is initiated, a Bluetooth device receives Bluetooth address information from the central control unit through an inquiry scan process and then connect with the central control unit through paging execution. If a connection setup is completed, the Bluetooth device performs Bluetooth communication by receiving packets periodically transmitted by the central control unit. However, Bluetooth is limited in application due to electric wave interference phenomenon.

A conventional encryption method for encrypting and decrypting data transmitted/received for unlocking in the conventional remote control system or smart key system using IrDA or Bluetooth communication is described below.

FIG. 1 is a diagram briefly illustrating an encryption process according to the conventional art. In the encryption process, a general plaintext 102 is inputted to an encryption algorithm 100 and a ciphertext 104 is outputted from the encryption algorithm 100. However, there is a serious problem if the encryption algorithm 100 is made available to the public at the time of encryption because any person can decrypt the ciphertext 104. As a complement solution to this, a key value serving as a kind of security element in an encryption/decryption process is added as shown in FIG. 2.

FIGS. 2A and 2B are diagrams illustrating encryption and decryption processes according to the conventional art. In the encryption process shown in FIG. 2A, a ciphertext is obtained by setting an input value (a plaintext plus a key value) 200 with a key value and then inputting the input value 200 to an encryption algorithm. Like the encryption process of FIG. 2A, in the decryption process of FIG. 2B, a plaintext is also obtained by setting an input value (a ciphertext plus a key value) 202 that is an addition of the key value to the ciphertext and then inputting the input value to a decryption algorithm.

Compared to the encryption scheme of FIG. 1, such a scheme advantageously guarantees even more security because the ciphertext cannot be decrypted without knowledge of the key value though the encryption algorithm is made available to the public. For reference, the key value, which is an arbitrary character stream, serves as a kind of security element for preventing the ciphertext from being decrypted without permission even when the encryption algorithm is made available to the public.

The encryption and decryption schemes of FIGS. 2A and 2B are divided roughly into a symmetric encryption algorithm and an asymmetric encryption algorithm. The symmetric encryption algorithm is an algorithm where the same key value is used for encryption and decryption. The asymmetric encryption algorithm is an algorithm where a different key value is used for encryption and decryption. In the symmetric encryption algorithm, the encryption/decryption speed is 10 times to 1000 times faster than that of the asymmetric encryption algorithm. Also, a ciphertext is smaller in size than a plaintext. So, upon encryption, there is no increase in size, and additional network bandwidth is not required. Because of the aforementioned advantage, the symmetric encryption algorithm is mainly used to encrypt data exchanged through communication. In the symmetric encryption algorithm, a data transmitting side and a data receiving side should have the same key because of its principle. In order for the transmitting and receiving sides to have the same key, in general, the transmitting side has to create and transmit a key to the receiving side over a network. However, this method is exposed to the danger of having an attacker intercept a key value in the middle of a transmission process.

Particularly, in a smart key system considering security as top priority, there is a problem that the symmetric encryption algorithm applied as above undesirably increases the possibility of theft/exposure of an encryption algorithm for an unlocking operation and if so, the smart key system has been already disqualified as a locking device. A smart key system that is vulnerable in security is made meaningless despite convenience of use. Thus, as a solution to the above problem associated with symmetric encryption algorithms, an encryption scheme using an asymmetric encryption algorithm that uses a different key value in the encryption/decryption process has been proposed.

In an asymmetric encryption algorithm, a transmitting side and a receiving side each create two keys that are called a private key (a secret key) and a public key, encrypt data using each public key, and transmit the encrypted data to each other. The private key (the secret key) is stored in each device and is used to decrypt the received data. The asymmetric encryption algorithm is generally called a public key algorithm in that data is encrypted using the public key and transmitted, thereby reducing a security risk even when a security key used for encryption is stolen or made available to the public.

### SUMMARY OF THE INVENTION

To address the above-discussed deficiencies of the prior art, it is a primary object to provide a smart key system for, upon Bluetooth communication and data transmission/reception, applying an asymmetric encryption algorithm and securely keeping data security during a communication process while performing unlocking or keyless entry functions of a plurality of locking devices using one mobile communication terminal, and an operating method thereof.

According to an aspect of the invention, there is provided a smart key system for enabling public key infrastructure (PKI)-based data transmission through local area wireless communication. The system includes a locking device and a mobile communication terminal. The locking device enables Bluetooth communication and enables PKI-based data transmission. The mobile communication terminal has a Bluetooth module embedded therein, and performs a remote unlocking or keyless entry function through Bluetooth communication with the locking device.

The locking device may include a Bluetooth module for enabling Bluetooth communication with the mobile communication terminal, a public key creator for enabling PKI-based data transmission, a public key encryption/decryption unit for encrypting/decrypting a public key created by the public key creator at the time the public key is transmitted/received to/from the mobile communication terminal, and an operation controller for controlling execution or non-execution of the unlocking function of the locking device depending on a remote keyless entry command/instruction of the mobile communication terminal.

The public key creator may randomly create the public key using Bluetooth address information that is set during a Bluetooth communication process.

The locking device may include all locking devices necessary for locking/unlocking a home or office door, a car door/starting device, and a desk drawer.

The mobile communication terminal may register all the locking devices as Bluetooth devices and singly perform the unlocking function of each locking devices using Bluetooth communication.

The mobile communication terminal may include a controller for controlling the general operation of the mobile communication terminal including an operation related to Bluetooth communication with a Bluetooth device including the locking device and an instruction or non-instruction of a keyless entry and unlocking command for the locking device, a Bluetooth module connected to the controller and performing a Bluetooth communication function, a memory including a public key creator, a communication unit connected to an antenna and having control of a data transmission/reception relation function, a display unit for displaying state information generated during an operation of the mobile communication terminal, a keypad including a plurality of alphanumeric keys and function keys and providing key input data from a user to the controller, and a COder/DECoder (codec) connected to the controller, a microphone, and a speaker.

According to another aspect of the invention, the invention provides a method for remote unlocking or keyless entry in a smart key system that has a locking device enabling Bluetooth communication and public key infrastructure (PKI)-based data transmission and a mobile communication terminal. The method includes maintaining a pairing state by connecting the locking device with the mobile communication terminal by Bluetooth communication, automatically transmitting, by the locking device, a public key to the mobile communication terminal, transmitting at regular intervals, by the locking device, a paging signal for determining whether there is a Bluetooth terminal having the transmitted public key, upon receiving the paging signal from the locking device, transmitting, by the mobile communication terminal, an unlocking or keyless entry command to the locking device, and upon receiving the unlocking command, decrypting, by the locking device, the unlocking command and performing an unlocking or keyless entry function.

The method may further include, after transmitting the public key by the locking device, automatically stopping an inquiry scan process such that other peripheral Bluetooth devices cannot search for the locking device.

In transmitting the public key by the locking device, the public key may be randomly created by a public key creator of the locking device and is different whenever there is a need for public key transmission.

In transmitting the public key by the locking device, the public key creator may randomly create the public key using a Bluetooth address from information on the mobile communication terminal set during a Bluetooth communication connection process and a different public key value may be used whenever transmission is performed.

In transmitting the unlocking command to the locking device by the mobile communication terminal, the command may be encrypted with the public key before transmission.

Transmitting the unlocking command to the locking device by the mobile communication terminal may further include transmitting the unlocking command by selecting and directly transmitting the received public key to the locking device though the mobile communication terminal fails to receive the paging signal from the locking device.

The method may further include, upon receiving the unlocking command from the mobile communication terminal, decrypting the unlocking command by the locking device using a private or secret key.

The method may further include, upon receiving the unlocking command from the mobile communication terminal, automatically maintaining a locking state by the locking device after lapse of a predetermined time.

The method may further include, upon receiving the unlocking command from the mobile communication terminal, automatically maintaining, by the locking device, a locking state by terminating the Bluetooth connection between the locking device and the mobile communication terminal if a distance between the mobile communication terminal and the locking device is more than a predetermined distance.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram briefly illustrating an encryption algorithm according to the conventional art;

FIGS. 2A and 2B are diagrams briefly illustrating encryption algorithm schemes according to the conventional art;

FIG. 3 is a block diagram illustrating a smart key system including a mobile communication terminal and a locking device that are equipped with Bluetooth modules according to an exemplary embodiment of the present invention;

FIG. 4 is a ladder diagram illustrating an operation of performing a remote unlocking or keyless entry function in a Public Key Infrastructure (PKI)-based Bluetooth smart-key system according to an exemplary embodiment of the present invention;

FIG. 5 is a flow diagram illustrating an operating method of a locking device that is an element of a PKI-based Bluetooth smart-key system according to an exemplary embodiment of the present invention; and

FIG. 6 is a flow diagram illustrating an operating method of a mobile communication terminal that is an element of a PKI-based Bluetooth smart-key system according to an exemplary embodiment of the present invention.

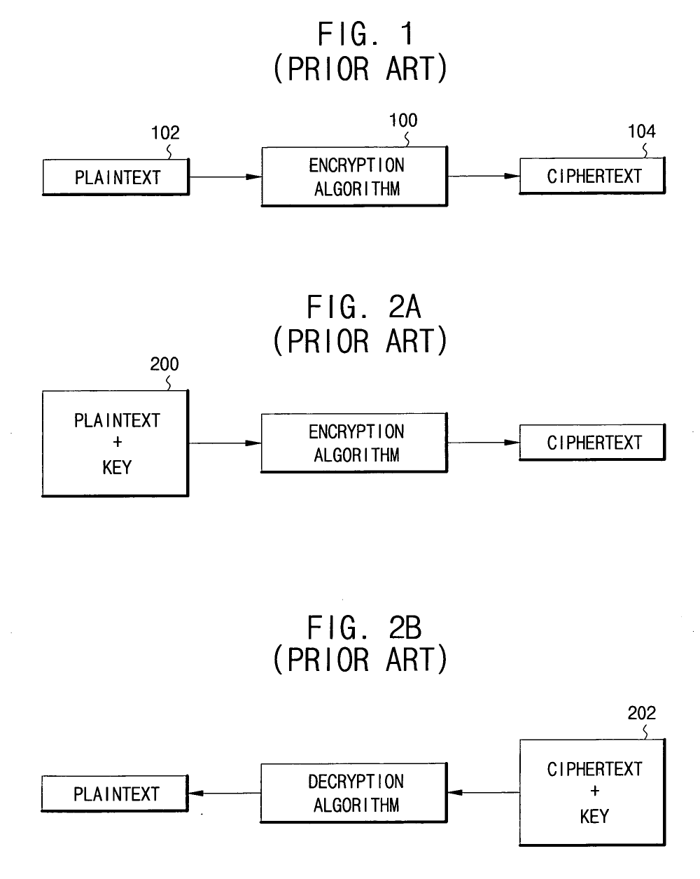

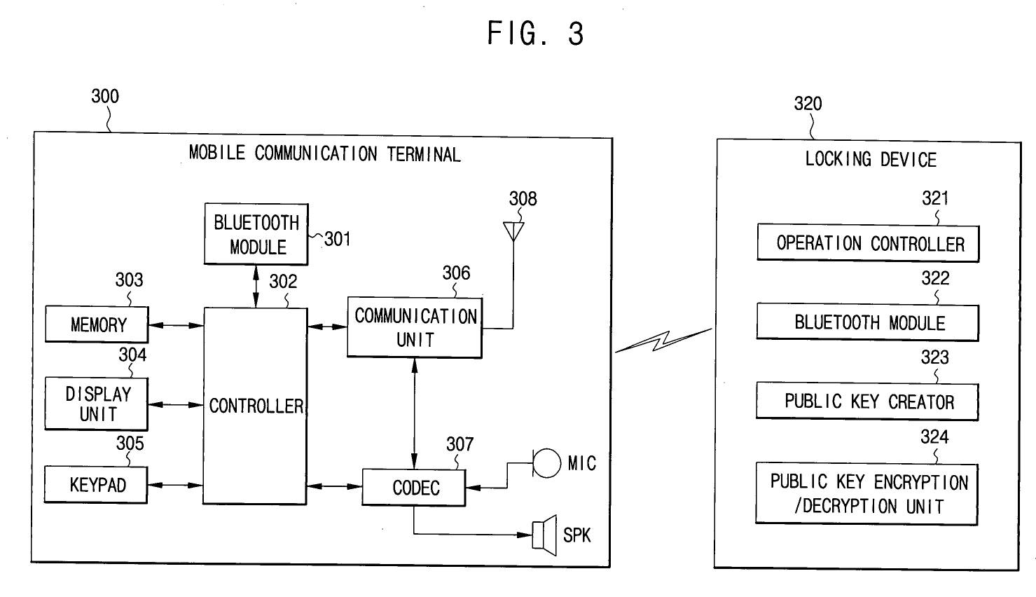

### DETAILED DESCRIPTION OF THE INVENTION

FIGS. 3 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following is a feature of two keys that are created by a transmitting side or a receiving side in the aforementioned PKI-based encryption algorithm. If data is encrypted using a public key of the transmitting side or the receiving side, the encrypted data can be decrypted only with a private key (a secret key) stored in the transmitting side or the receiving side. Inversely, if data is encrypted using the private key (the secret key) of the transmitting side or the receiving side, the encrypted data can be decrypted only with the public key of the transmitting side or the receiving side. Thus, though theft or exposure of the public key takes place in the middle of each data transmission process in a data transmission/reception process, if the transmitting side and the receiving side transmit data encrypted using the public keys to each other, the encrypted data can be securely decrypted using each private key (secret key). The greatest advantage of the application of the PKI-based encryption algorithm is to enable secure communication even when the public key used for encrypting data is known to the public in the middle of a communication process.

The present invention will now be described more fully hereinafter with reference to the accompanying drawings. In the following description, well-known functions or constructions are not described in detail since they would obscure the invention in unnecessary detail.

The present invention is configured to securely perform a remote unlocking operation of a smart key system by encrypting or decrypting a remote unlocking request or command between a locking device and a mobile communication terminal equipped with Bluetooth modules using Bluetooth communication and a PKI-based encryption algorithm and control all of several locking devices using one mobile communication terminal. The present invention is described with reference to FIGS. 3 to 6.

FIG. 3 is a block diagram illustrating a construction of a PKI-based Bluetooth smart-key system according to an exemplary embodiment of the present invention.

As shown in FIG. 3, the PKI-based Bluetooth smart-key system includes a mobile communication terminal 300 and a locking device 320. The mobile communication terminal 300 is a Bluetooth client that attempts Bluetooth communication connection. The locking device 320 is equipped with a Bluetooth module 322 that is a Bluetooth server. The smart key system requests and controls a remote unlocking or keyless entry operation by transmitting data encrypted based on PKI in a Bluetooth communication connection state. FIG. 3 shows only one locking device for easy understanding of the description, but it should be noted that a plurality of locking devices can connect with the mobile communication terminal 300 by Bluetooth.

The mobile communication terminal 300 includes a Bluetooth module 301, a controller 302, a memory 303, a display unit 304, a keypad 305, a communication unit 306, and a COder and DECoder (codec) 307. The locking device 320 includes an operation controller 321, the Bluetooth module 322, a public key creator 323, and a public key encryption/decryption unit 324.

In the mobile communication terminal 300, the Bluetooth module 301 searches for the locking device 320 connectable under the control of the controller 302, pairs with the locking device 320 using an authentication key of the locking device 320 stored in a Bluetooth DataBase (DB) or an authentication key of the locking device 320 inputted at the time there is a need for authentication, and exchanges data with the locking device 320 through the Bluetooth module 322 of the locking device 320 if Bluetooth connection is established.

In the mobile communication terminal 300, the controller 302 controls the standard, general operation of the mobile communication terminal 300 including an unlocking operation or a keyless entry function of the locking device 320 by Bluetooth communication with the locking device 320. The memory 303 includes a public key creator (not shown) that is used to encrypt a remote unlocking command. The memory 303 includes a Bluetooth DB for storing a program for operation of the controller 302 and necessary data for registering a Bluetooth device.

In the mobile communication terminal 300, the display unit 304 displays state information generated during operation of the mobile communication terminal 300. The keypad 305 includes a plurality of function keys and provides key input data from a user to the controller 302.

The communication unit 306 performs substantial communication in connection with the controller 302 and an antenna 308. The codec 307 connects with a microphone (MIC) and a speaker (SPK) and performs audio processing necessary for a communication process.

In the locking device 320, the operation controller 321 controls the general operation including Bluetooth communication connection and locking/unlocking. Under the control of the operation controller 321, the Bluetooth module 322 performs the general operation for establishing Bluetooth communication connection such as transmission of a connection enable signal, transmission of an authentication key request signal, and pairing and exchanging data once Bluetooth connection is established.

In the locking device 320, the public key creator 323 creates a public key used for transmission of data encrypted based on PKI, during Bluetooth communication connection. The public key is randomly created using Bluetooth address information of the mobile communication terminal 300 set after Bluetooth communication connection as a seed value for a random function. In the locking device 320, the public key encryption/decryption unit 324 encrypts the public key at the time there is an unlocking request, and decrypts the public key to carry out a received command.

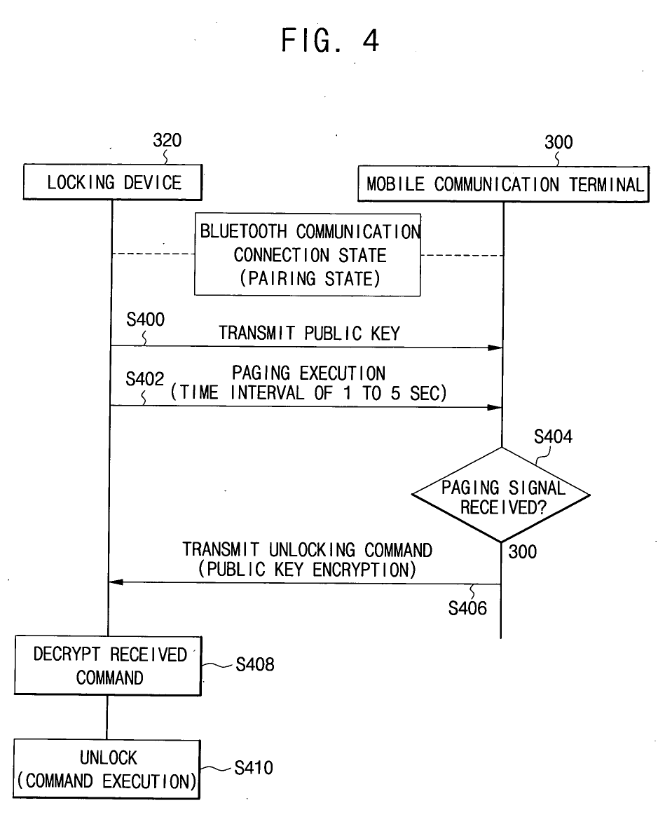

An operating method of the above-constructed PKI-based Bluetooth smart-key system according to the present invention is described below with reference to FIGS. 4 to 6.

FIG. 4 is a ladder diagram illustrating an operation of performing a remote unlocking or keyless entry function of a PKI-based Bluetooth smart-key system according to an exemplary embodiment of the present invention.

For operation of the PKI-based Bluetooth smart-key system of the present invention, the mobile communication terminal 300 and the locking device 320 have to maintain a pairing state by connecting with each other over a Bluetooth network. Pairing is when the mobile communication terminal enabling Bluetooth communication searches for the locking device, and the locking device authenticates the mobile communication terminal using a Bluetooth link key.

If the locking device 320 is paired with the mobile communication terminal 300, the locking device 320 automatically transmits a public key created by the public key creator 323 of the locking device 320 to the mobile communication terminal 300 (S400). Here, the public key used is randomly created using Bluetooth address information of the mobile communication terminal 300 that is set at the time a Bluetooth communication connection is established. A different value is used whenever there is a request for an unlocking operation. Therefore, the public key can act as another aspect of an increased security method by preventing the reuse of the public key once made available to the public in the smart key system.

After transmitting the public key to the mobile communication terminal 300, the locking device 320 transmits a paging signal for paging execution to the mobile communication terminal 300, which has the public key transmitted by the locking device 320 itself, at regular intervals of about 1 to 5 seconds (S402).

Then, the mobile communication terminal 300 having the public key determines whether it received the paging signal from the locking device 320 by determining whether the locking device 320 transmitted the paging signal (S404). If the paging signal is received, the mobile communication terminal 300 transmits a command for execution of an unlocking or keyless entry function of the locking device 320 to the locking device 320 (S406). Here, the unlocking command transmitted by the mobile communication terminal 300 is also encrypted with the public key.

Upon receiving the unlocking command from the mobile communication terminal 300, the locking device 320 decrypts the unlocking command using a private key (a secret key) stored in the locking device 320 itself (S408) and then performs an unlocking operation according to the unlocking command (S410).

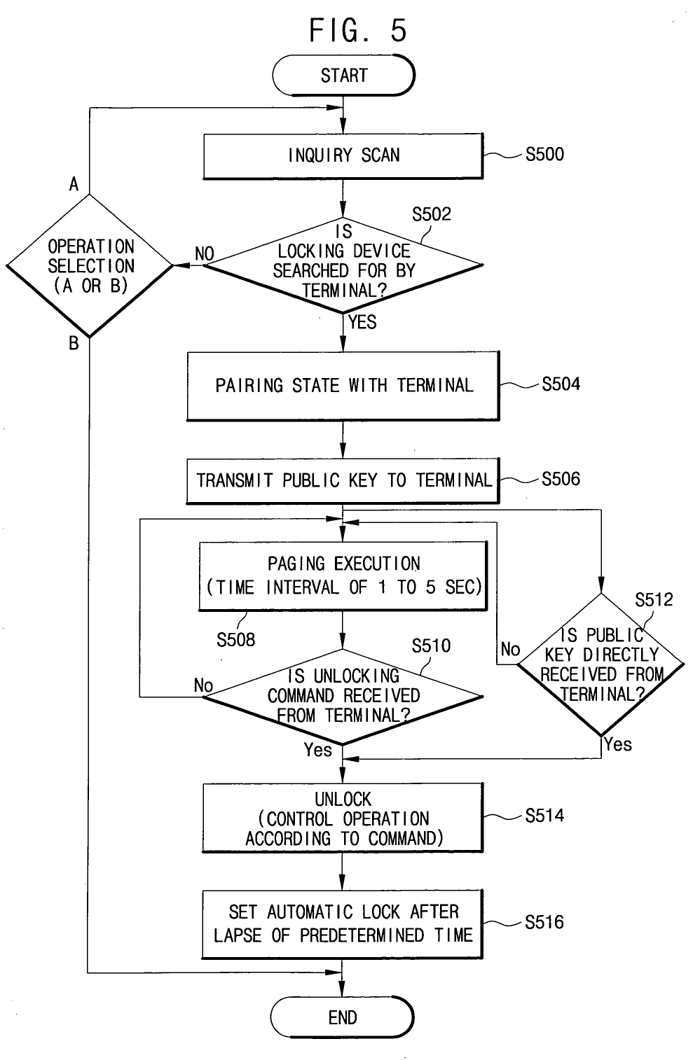

FIG. 5 is a flow diagram illustrating a detailed operation or event processing operation of a locking device in an operating method of a PKI-based Bluetooth smart-key system according to the present invention.

As shown in FIG. 5, a locking device 320 equipped with a Bluetooth module performs an inquiry scan that is an initial setup operation of Bluetooth communication (S500), so the locking device 320 can be searched for by other Bluetooth communication devices (including a mobile communication terminal). The locking device 320 equipped with the Bluetooth module should be previously registered as a Bluetooth device with the mobile communication terminal 300. After performing the inquiry scan, the locking device 320 determines whether the locking device 320 is searched for by the mobile communication terminal 300 (S502). If the locking device 320 is being searched for by the mobile communication terminal 300 during the inquiry scan, the mobile communication terminal 300 and the locking device 320 are paired with each other, thus forming a fundamental operating environment or condition of the smart key system using Bluetooth communication according to the present invention (S504).

If the locking device 320 is not searched for by the mobile communication terminal 300 in the S502, the locking device 320 can repeatedly perform the inquiry scan operation (select an ‘A’ operation) or stops the search (select a ‘B’ operation) depending on operation selection.

If the locking device 320 is paired with the mobile communication terminal 300 through a Bluetooth communication connection in the S504, in this state, the locking device 320 transmits a public key to the mobile communication terminal 300 (S506) and simultaneously, automatically stops the inquiry scan such that other devices cannot search out the locking device 320. Here, the public key transmitted by the locking device 320 is randomly created by a public key creator of the locking device 320 and has a different value whenever there is a need for public key transmission. Therefore, there is an effect that, though the public key is stolen/made available to the public in the middle of a transmission process, the danger of theft is reduced and the security of the operation of the smart key system is increased by preventing the reuse of the public key once it is made available to the public.

After transmitting the public key in the S506, the locking device 320 transmits a paging signal to determine whether the mobile communication terminal 300 (a Bluetooth terminal) has the public key transmitted by the locking device 320, using Bluetooth address information that is received at the time pairing is performed, by performing a paging scan at regular intervals of about 1 to 5 seconds (S508). Then, the locking device 320 determines whether it receives a command for execution of an unlocking or keyless entry function from the mobile communication terminal 300 which received the paging signal (S510).

If the locking device 320 receives the unlocking command from the mobile communication terminal 300 (S510), the locking device 320 performs an unlocking operation or keyless entry function, that is, an operation according to the command received from the mobile communication terminal (S514). Otherwise, the locking device 320 returns to the S508 and repeatedly performs the paging scan.

In order to implement the unlocking operation in the S514, the locking device 320 decrypts the unlocking command received from the mobile communication terminal 300 using a private key (a secret key) that is held by the locking device 320. By doing so, the locking device 320 can securely carry out the remote unlocking command. That is because only an internal private key (secret key) necessary for corresponding data decryption makes it possible to substantially execute the unlocking operation though the public key is made available to the public in the middle of transmitting data encrypted with the public key during a Bluetooth communication process in the operation of the smart key system of the present invention.

The unlocking operation of the S514 can be implemented also by allowing the mobile communication terminal 300 to directly select and transmit the public key transmitted by the locking device 320 to the locking device without the paging signal transmission process (S508) of the locking device 320. That is, the locking device 320 determines whether it directly receives the public key for unlocking from the mobile communication terminal 300 (S512) for the unlocking operation of the locking device 320. If the public key is directly received, the locking device 320 can perform the unlocking operation using the received public key (S514). If the public key is not directly received, the locking device 320 returns to the S508 and executes the paging scan, receives the unlocking command from the mobile communication terminal 300 (S510), and performs the unlocking operation (S512).

Then, if Bluetooth connection is lost due to the lapse of a predetermined time lapses or a distance between the locking device 320 and the mobile communication terminal 300 is larger than a predetermined distance of about 2 m, the locking device 320 being in an unlocking state of the S514 is automatically again set and kept in a locking state (S516). So, the locking device 320 can be conveniently operated even without a separate process of setting a locking function to the locking device 320.

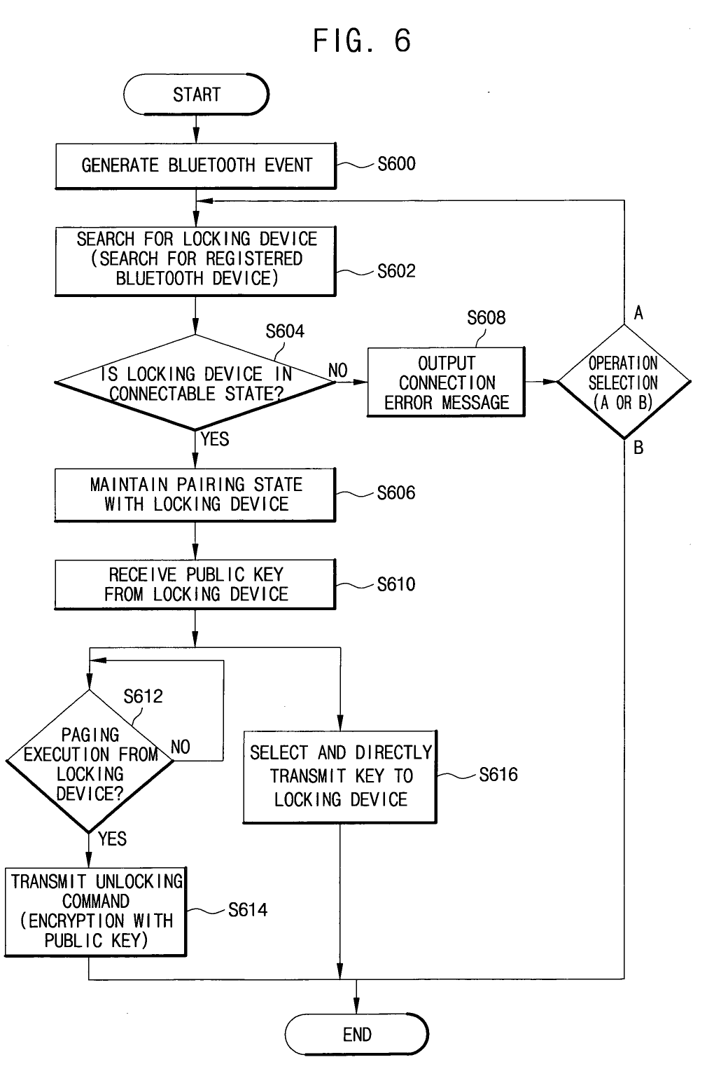

FIG. 6 is a flow diagram illustrating a detailed operation or event processing operation of a mobile communication terminal in an operating method of a PKI-based Bluetooth smart-key system according to the present invention.

As shown in FIG. 6, the mobile communication terminal 300 generates a connection event for Bluetooth communication to control a remote unlocking or keyless entry operation of a locking device 320 (S600).

If the Bluetooth event is generated, the mobile communication terminal 300 determines whether the locking device 320 previously registered as a Bluetooth device with the mobile communication terminal 300 is Bluetooth connected (S602) and as a result, determines whether the locking device 320 is in a connectable state (S604).

If the locking device 320 is in a connectable state, the mobile communication terminal 300 is paired with the locking device 320 using an authentication key of the locking device 320 to be connected and maintains a Bluetooth communication connection (S606).

If the locking device 320 is not in a connectable state in the S604, the mobile communication terminal 300 outputs a connection error message through its display unit (S608). Then, the mobile communication terminal 300 keeps searching the locking device 320 registered as a Bluetooth device in the S602 (an ‘A’ operation) or stops searching the Bluetooth device (a ‘B’ operation) according to operation selection.

After maintaining the pairing with the locking device (the S606), the mobile communication terminal 300 receives a public key from the locking device 320 (S610). Then, the mobile communication terminal 300 determines whether it receives a paging signal from the locking device 320 (S612).

If the paging signal is received from the locking device 320, the mobile communication terminal 300 automatically transmits an unlocking or keyless entry command to the locking device 320 (S614). Here, the command is also encrypted using the public key created in a memory of the mobile communication terminal 300 and is transmitted.

After receiving the public key from the locking device 320 in the S610, the mobile communication terminal 300 can search and directly transmit the public key stored in the mobile communication terminal 300 to the locking device 320 (S616) and control the unlocking operation of the locking device 320 without going through the S612.

As described above, the locking device of the PKI-based Bluetooth smart-key system can include all locking devices necessary for locking/unlocking a home or office door, a car door/starting device, a desk drawer, etc., for example.

As described above, the smart key system using PKI-based data transmission and Bluetooth communication according to the present invention has an effect of controlling all unlocking or keyless entry operations of several locking devices using one mobile communication terminal, thereby eliminating the inconvenience of maintaining several physical unlocking tools (e.g., keys) according to need and promoting a convenience of use. Also, the smart key system has an effect of reducing the danger of theft or exposure, increasing security, and securely implementing an unlocking operation of a locking device. Though data transmission in the smart key system is based on PKI and a public key used for encryption is made available/stolen in the course of transmission of a remote command encrypted with the public key, it is impossible to carry out the command without using a private key (a secret key) stored as proper information in the locking device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A smart key system for enabling data transmission through local area wireless communication, comprising:
a locking device for enabling Bluetooth communication and enabling public key infrastructure-based data transmission,
wherein the locking device receives a remote unlocking or keyless entry command from a mobile communication terminal through Bluetooth communication with the mobile communication terminal and performs a remote unlocking or keyless entry function associated with the command.

2. The system of claim 1, wherein the locking device comprises:
a Bluetooth module for enabling Bluetooth communication with the mobile communication terminal;
a public key creator for enabling public key infrastructure-based data transmission;
a public key encryption/decryption unit for encrypting/decrypting a public key created by the public key creator at a time the public key is transmitted/received to/from the mobile communication terminal; and
an operation controller for controlling execution of the unlocking function of the locking device depending on a remote keyless entry command from the mobile communication terminal.

3. The system of claim 2, wherein the public key creator selectively randomly creates the public key using Bluetooth address information that is set during a Bluetooth communication process.

4. The system of claim 1, wherein the locking device comprises all locking devices necessary for locking/unlocking a home or office door, a car door/starting device, and a desk drawer.

5. A smart key system for enabling data transmission through local area wireless communication, comprising:
a mobile communication terminal having a Bluetooth module embedded therein, and transmitting a remote unlocking or keyless entry command through Bluetooth communication to a locking device, the locking device enabling Bluetooth communication and enabling public key infrastructure-based data transmission,
wherein the locking device performs a remote unlocking or keyless entry function associated with the command.

6. The system of claim 5, wherein the locking device comprises all locking devices necessary for locking/unlocking a home or office door, a car door/starting device, and a desk drawer.

7. The system of claim 6, wherein the mobile communication terminal registers all the locking devices as Bluetooth devices and singly performs the unlocking function of each locking device using Bluetooth communication.

8. The system of claim 5, wherein the mobile communication terminal comprises:
a controller for controlling a general operation of the mobile communication terminal that comprises an operation related to Bluetooth communication with a Bluetooth device comprising the locking device and a keyless entry or unlocking command for the locking device;
a Bluetooth module connected to the controller, and performing a Bluetooth communication function;
a memory comprising a public key creator;
a communication unit connected to an antenna, and having control of a data transmission/reception function;
a display unit for displaying state information generated during an operation of the mobile communication terminal;
a keypad comprising a plurality of alphanumeric keys and function keys and providing key input data from a user to the controller; and
a coder-decoder connected to the controller, a microphone, and a speaker.

9. A method for remote unlocking or keyless entry in a smart key system that has a locking device, enabling Bluetooth communication and public key infrastructure-based data transmission, and a mobile communication terminal, the method comprising:
maintaining a pairing state by connecting the locking device with the mobile communication terminal by Bluetooth communication;
automatically transmitting, by the locking device, a public key to the mobile communication terminal;
transmitting at regular intervals, by the locking device, a paging signal for determining whether there is a Bluetooth terminal having the transmitted public key; and
upon receiving an encrypted unlocking or keyless entry command from the mobile communication terminal, decrypting, by the locking device, the unlocking or keyless entry command and performing an unlocking or keyless entry function associated with the command.

10. The method of claim 9, further comprising: after transmitting the public key by the locking device, automatically stopping an inquiry scan process such that peripheral other Bluetooth devices are not able to search for the locking device.

11. The method of claim 9, wherein in transmitting the public key by the locking device, the public key is randomly created by a public key creator of the locking device and is used differently whenever there is a need for public key transmission.

12. The method of claim 9, wherein in transmitting the public key by the locking device, the public key creator randomly creates the public key using a Bluetooth address that is proper information on the mobile communication terminal set during a Bluetooth communication connection process and a different public key value is used whenever transmission is performed.

13. The method of claim 9, further comprising: upon receiving the unlocking command from the mobile communication terminal, decrypting, by the locking device, the unlocking command using a private or secret key.

14. The method of claim 9, further comprising: upon receiving the unlocking command from the mobile communication terminal, automatically maintaining, by the locking device, a locking state after lapse of a predetermined time.

15. The method of claim 9, further comprising: upon receiving the unlocking command from the mobile communication terminal, automatically maintaining, by the locking device, a locking state by disconnecting Bluetooth connection between the locking device and the mobile communication terminal if a distance between the mobile communication terminal and the locking device is kept more than a predetermined interval.

16. A method for remote unlocking or keyless entry in a smart key system that has a locking device, enabling Bluetooth communication and public key infrastructure-based data transmission, and a mobile communication terminal, the method comprising:
maintaining a pairing state by connecting the locking device with the mobile communication terminal by Bluetooth communication;
receiving, by the mobile communication terminal, a public key from the locking device;
receiving, by the mobile communication terminal, a paging signal from the locking device; and
upon receiving the paging signal, transmitting, by the mobile communication terminal, an encrypted unlocking or keyless entry command to the locking device.

17. The method of claim 16, wherein transmitting the unlocking command to the locking device by the mobile communication terminal further comprises encrypting the unlocking or keyless entry command with the public key before transmitting.

18. The method of claim 16, wherein transmitting the unlocking command to the locking device by the mobile communication terminal further comprises: transmitting the unlocking command by selecting and directly transmitting the received public key to the locking device though the mobile communication terminal fails to receive the paging signal from the locking device.
